(19) United States
(12) Patent Application Publication
(10) Pub. No.: US 2025/0060476 A1
(43) Pub. Date: Feb. 20, 2025

(54) RADIO FREQUENCY IMAGING APPARATUS AND METHOD

(71) Applicant: OULUN YLIOPISTO, Oulu (FI)

(72) Inventors: Nuutti TERVO, Oulu (FI); Marko LEINONEN, Oulu (FI); Praneeth SUSARLA, Oulu (FI)

(21) Appl. No.: 18/723,246

(22) PCT Filed: Dec. 16, 2022
(86) PCT No.: PCT/EP2022/086409

§ 371 Date: Jun. 21, 2024

(30) Foreign Application Priority Data
Dec. 23, 2021 (FI) 20216344

(51) Int. Cl. G01S 13/89; G01S 7/41; G01S 13/00; G01S 13/50; G01S 13/72; G01S 13/86

(52) U.S. Cl. CPC G01S 13/89; G01S 7/415; G01S 7/417; G01S 13/003; G01S 13/50; G01S 13/72; G01S 13/867

(57) ABSTRACT

A radio frequency imaging apparatus comprises a radio frequency receiver (16), which receives radio frequency electromagnetic radiation interacted with a non-stationary object (12) and forms, as a function of time, at least one property of the radio frequency radiation interacted with the object (12), the non-stationarity of the object (12) relating to at least one of the following: a direction from which the radio frequency radiation hits the object (12), a position of the receiver (16). A data gathering unit (18) gathers information on position and/or orientation of the object (12) as a function of time, and forms, as a function of time, information on position and/or orientation of the object (12) within the radio frequency radiation from the gathered data. A data processing unit (10) forms at least one radio frequency image of the object (12) from both of said information on position and/or orientation of the object (12) and the at least one property of the radio frequency radiation interacted with the object (12), the data processing unit (10) utilizing temporal relation between the at least one radio frequency property and information on the position and/or orientation of the object (12) in formation of the radio frequency image.

### FIELD

The invention relates to an electromagnetic radio frequency imaging apparatus and a corresponding radio frequency imaging method.

### BACKGROUND

Imaging based on radio frequency electromagnetic radiation is a fairly new technology for gathering information on objects. Radio frequency radiation can be defined to be within a frequency range from about 300 MHz to terahertz region. Electromagnetic radiation in that range is non-ionising and can be used safely.

Imaging solutions in the terahertz-range utilize information that is provided only by the radio. In the very basic (tomography) principle of the imaging, the images can be synthesized by transmitting radio frequency radiation toward an object from multiple physical positions using multiple transmitters or accurately moving the object physically, and receiving the radio frequency radiation transmitted to these directions or object orientations. A challenge is that they either require possibility to move the object, transmitter, and/or receiver very accurately, or have multiple parallel links, multiple antennas, multiple beams etc. that together can then be used to create an image. Physically controlled movement of the object is slow and rather impractical while multiple antennas, links, beamforming etc. require very complicated hardware and possibility to control the hardware. In many cases, such control even requires access to the internal operation of the system such as beamforming, signal processing, detection etc. that is not possible by only third-party software in many commercial wireless communication devices and platform. Hence, an improvement for the radio frequency imaging would be welcome.

### BRIEF DESCRIPTION

The present invention seeks to provide an improvement in the measurements.

The invention is defined by the independent claims. Embodiments are defined in the dependent claims.

If one or more of the embodiments is considered not to fall under the scope of the independent claims, such an embodiment is or such embodiments are still useful for understanding features of the invention.

### LIST OF DRAWINGS

Example embodiments of the present invention are described below, by way of example only, with reference to the accompanying drawings, in which

FIG. 1A illustrates an example of a system where a radio frequency image is formed;

FIG. 1B illustrates an example where the radio frequency signal is reflected from a reflecting material toward an object;

FIG. 1C illustrates an example where the radio frequency signal reflects and/or scatters from the object;

FIG. 1D illustrates an example where a transmitter is moving causing non-stationarity of the object with respect to direction of the radio frequency signal;

FIG. 1E illustrates an example where the receiver is moving causing non-stationarity of the object with respect to the receiver;

FIGS. 2 and 3 illustrates an example of the data processing unit;

FIG. 4 illustrates an example of receiver with receiving elements;

FIG. 5 illustrates an example of focusing electromagnetic radio frequency radiation;

FIG. 6 illustrates an example of marks for tracking;

FIG. 7 illustrates an example of radio frequency image;

FIG. 8 illustrates an example of formation of a Fresnel-zone; and

FIG. 9 illustrates of an example of a flow chart of a radio frequency imaging method.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment.

The articles “a” and “an” give a general sense of entities, structures, components, compositions, operations, functions, connections or the like in this document. Note also that singular terms may include pluralities.

Single features of different embodiments may also be combined to provide other embodiments. Furthermore, words “comprising” and “including” should be understood as not limiting the described embodiments to consist of only those features that have been mentioned and such embodiments may also contain features/structures that have not been specifically mentioned. All combinations of the embodiments are considered possible if their combination does not lead to structural or logical contradiction.

The term “about” means that quantities or any numeric values are not exact and typically need not be exact. The reason may be tolerance, resolution, measurement error, rounding off or the like, or a fact that the feature of the solution in this document only requires that the quantity or numeric value is approximately that large. A certain tolerance is always included in real life quantities and numeric values.

It should be noted that while Figures illustrate various embodiments, they are simplified diagrams that only show some structures and/or functional entities. The connections shown in the Figures may refer to logical or physical connections. It is apparent to a person skilled in the art that the described apparatus may also comprise other functions and structures than those described in Figures and text. It should be appreciated that details of some functions, structures, and the signalling used for measurement and/or controlling are irrelevant to the actual invention. Therefore, they need not be discussed in more detail here.

Improvements in radio communication technologies, for example, have also developed possibilities for electromagnetic radio frequency imaging, which can be used for gathering information on objects. Radio frequency radiation can be defined range from a region of megahertzes to terahertzes. Electromagnetic radiation in that range is non-ionising and can be used safely.

Radio frequency (RF) imaging is usually performed at millimeter-wave (mmW) or THz regions because using high frequencies enables to see accurately smaller objects due to the shorter wavelength and larger antenna aperture that gives good spatial resolution. In general, imaging systems can be based on, for example, tomography, spectroscopy, or other radar techniques.

Tomography is based on penetration of the propagating radio wave through the object, spectroscopy is based on frequency selective absorption and reflection properties of the materials and shapes, while other radar techniques are based on reflections, diffraction, scattering, and other multipath phenomena that the transmitted wave is affected when propagating from the transmitter (TX) to the receiver (RX). High frequency radars, spectroscopy equipment and other RF imaging systems that can capture the geometric shape of the object are usually based on using multiple transmitter and receiver antennas, sometimes together with directive radio lenses. For example, using multiple antennas in radars enable highly directive beams that can be directed and/or focused to a certain physical position to excite and receive radio waves affected by the object. This enables good resolution for determining the spatial shape of the object. Changing the focus to different positions of the object enables to generate multiple pixels that than together creates the image of the object. In lens-based imaging solutions, the meaning of these pixels is similar to normal cameras operating in the visible light region. Note that compared to normal cameras, radio imaging may also see inside the object due to the electrical properties of different materials.

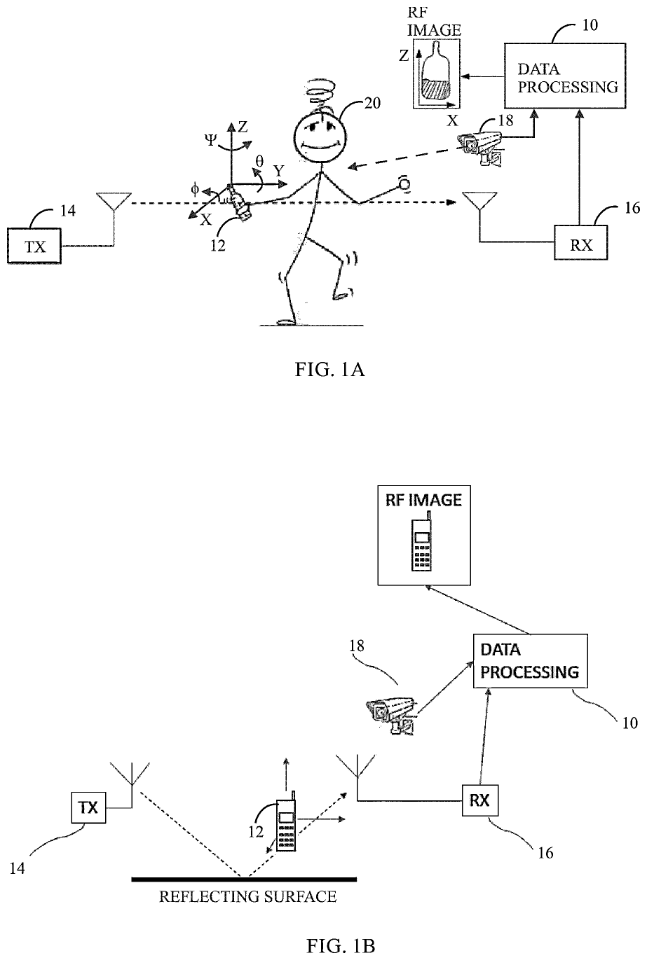

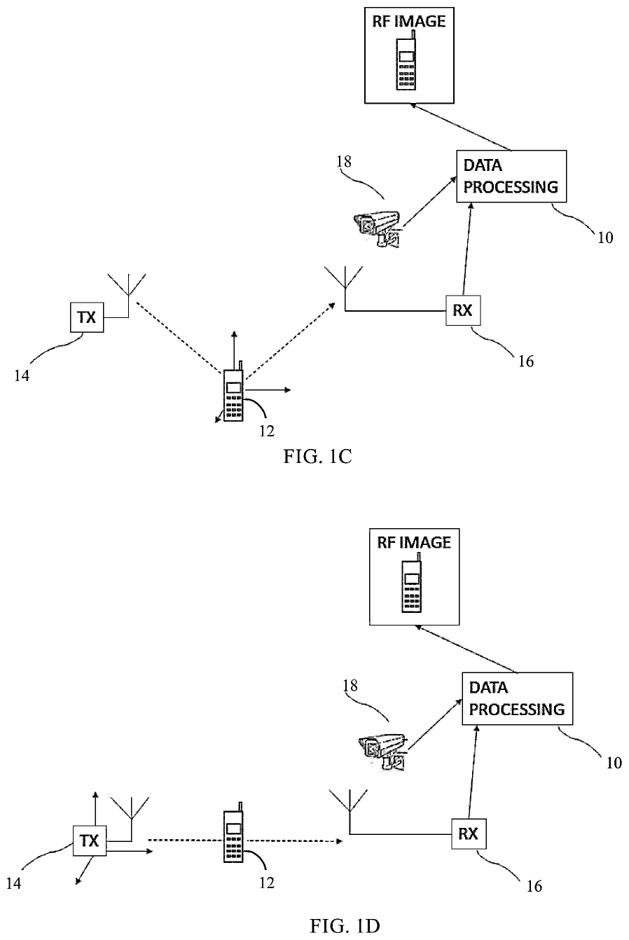

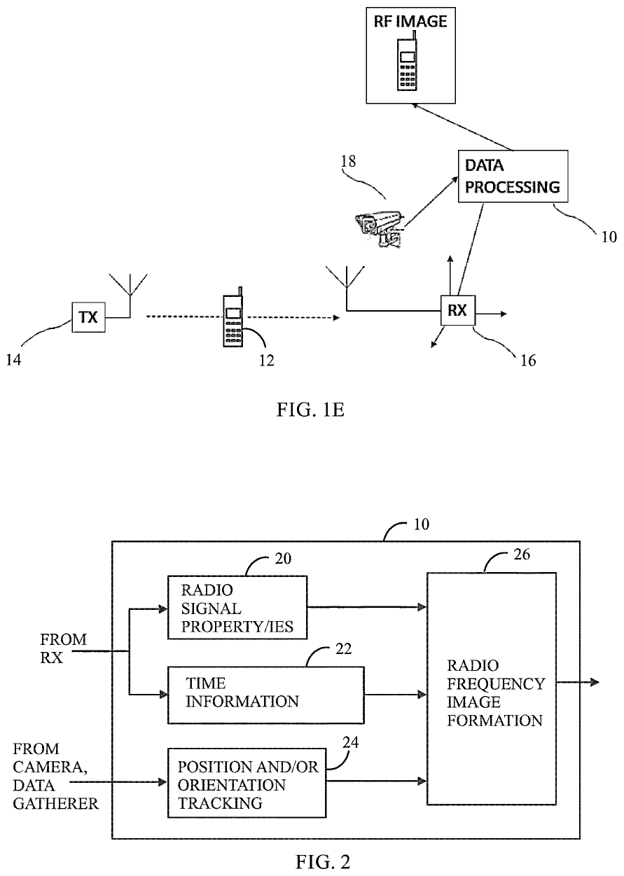

A radio image of an object 12 (see FIG. 1) can be synthetized by combining a radio signal information, and/or a radio signal quality indicator or some other radio signal parameter with the object position and/or orientation information, which may be provided by image processing using regular camera data. Combining these two pieces of information together provides a simple and efficient way of performing radio imaging in practice.

The combination of the information may utilize pixel coordinates (X, Y, Z, phi (φ, roll), theta (θ, pitch), psi (ψ, yaw)) of an image of the object 12 from a camera, while the radio signal parameter, such as received signal strength (RSS) provides the color, shape, filling rate, structure, composition, transparency, or the like information on that particular pixel. Due to the fact that the object 12 is likely to move in the environment over time, the movement changes the coordinates of the object 12 that enables of having multiple pixels in the image.

The object position may be varying nearly randomly from the imaging system point of view and does not need to be physically controlled by the system. Instead, the object 12 is let to move in the environment and its position and orientation information is collected as it is. This creates, so called, random pixel coordinates for the radio images. Over time, it is likely that the object 12 moves in such a way that the overall picture can be formed based on these pixel positions and the corresponding radio signal information and/or the signal quality indicator samples.

Hence, high resolution radio frequency image can be provided without need for high number of physical antennas/links/beams, or controlled movement of the object 12. Generally, antenna radiation pattern forms a beam.

In short, a radio frequency picture may be formed by taking position and/or orientation coordinates from (X, Y, Z, phi (φ), theta (θ), psi (ψ)) from data of at least one optical image capturing unit 18, and a corresponding radio frequency data from the radio signal property. These two are captured in a synchronous manner with respect to each other. Alternatively or additionally, the coordinate system may be a cylindrical coordinate system and/or a spherical coordinate system, for example.

Commercial radio frequency (RF) and terahertz (THz) imaging systems are often rather expensive due to the fact that they require a high number of pixels for generating meaningful images. The prize of the devices makes the RF imaging solutions very specialized for certain applications, such as security screening in the airport, or laboratory studies of the electrical properties of different materials etc. The requirement of having multiple pixels can be relaxed by using so called synthetic aperture radar techniques or virtual antenna arrays. These can be realized by moving the object accurately between the transmitter (TX) and receiver (RX), or moving the TX and/or RX around the object and measure the image pixel by pixel in different time instants. However, such arrangement requires accurate positioners, and the mechanical movement of the antennas or the object 12 requires significant amount of time.

The positioners are usually configured to move the object 12 with a constant speed or stop the object in each physical pixel coordinates in order to form an image with a standard uniform grid. The same applies for, so called, THz cameras, where the image pixels are created based on lens antennas that focus different parts of the object to different physical receivers placed behind the lens.

On the other hand, current communication systems such as WiFi or fifth generation (5G) are already utilizing mmW frequencies for wireless communications and these systems use antenna arrays and/or lens antennas to enhance the link performance and enable higher data rates. Moreover, future sixth generation (6G) are envisioned to go even higher in the frequency to enable communications at >100 GHz up to even THz region. In these frequencies, it is possible to make very accurate imaging over several meter link distances by using the properties of the communication link. Using lens antennas and/or very large antenna arrays enables to make focusing to reduce the beamwidth at the object position to improve the image resolution. These high-frequency transceivers are envisioned to be integrated even in a mobile device to enable extremely fast data rates.

One or more cameras may be used as data gathering units that gather information on position and/or orientation of the object 12 with respect to the radio frequency signal and/or the receiver of the radio frequency signal. The cameras may generate high resolution images and/or videos in electric form, and they are nowadays relatively low-cost devices. They can be or are already integrated in many devices such as in mobile phones. Computer vision, with the advancements in image processing and artificial intelligence has made great progress such that detecting and tracking a certain visible object from a video is rather straight forward and many solutions exist. In image processing and computer vision terms, detection usually means estimating object position and orientation in an image whereas tracking usually corresponds to predicting object position and orientation in subsequent frames of a video sequence by using objects or cameras motion information.

FIG. 1 illustrates an example of a system where a radio frequency image is formed. The radio frequency image means a representation of structural and/or compositional variation of the object 12. The radio frequency image reveals differences in the dielectric properties in different areas of the object 12. Hence, an outline of the object 12 can be imaged and also internal structures and/or compositions of the object 12 based on the resolution of the imaging system. A radio frequency imaging apparatus comprises at least one data processing unit 10. The at least one data processing unit 10 receives information on at least one radio frequency property of radio frequency radiation interacted with a non-stationary object 12 as a function of time. The at least one data processing unit 10 also receives information on position and/or orientation of the object 12 within the radio frequency radiation as a function of time. A radio frequency transmitter 14 transmits one or more beams of electromagnetic radiation at one or more radio frequencies. The frequency range of the electromagnetic radiation may be in a range from about 100 kHz to about 10 THz, for example, without limiting to this.

Here the non-stationarity of the object 12 relates to at least one of the following: a direction, position and/or orientation from which or in which the radio frequency radiation is configured to hit the object 12, a position and/or orientation of the receiver 16, a position and/or orientation of the transmitter 14.

That is, a direction of the radio frequency radiation with respect to the object 12 can indicate the position and/or orientation of a moving object 12 and also the position and/or orientation of an object 12 that may be still with respect to its environment while the radiofrequency transmitter 14 and/or the receiver 16 is moving.

Hence, if the object 12, and/or receiver 16, and/or transmitter 14 changes their position and/or orientation between data capture instants, the object 12 can be defined as non-stationary. Note that if the transmitter and/or receiver are/is equipped with an additional repeater arrangement that has impact on the direction or position from which or in which the radio frequency radiation is configured to hit the object 12, this can be still interpreted as non-stationarity of the object 12.

At higher frequencies the radio links typically are more directive, in order to enhance the link range, which enables better imaging resolution. Also, the electromagnetic properties of different materials vary a lot over different frequencies which is often taken advantage in spectroscopy applications. For example, water molecules have a resonance frequencies at around 22.235 GHz and 183.31 GHz and a vibrational frequency at 2.45 GHz and 5 GHz, but it may also vary a lot depending on the temperature, purity, etc. of the water. In high frequencies also the penetration loss of different materials often increases which may mean that the system has to either increase the transmit power or decrease the noise in the receiver by signal processing techniques and averaging. Hence, different frequencies have different advantages from the system perspective.

In communication systems, the high loss is not usually an advantage and limits their usability in very high frequencies when the line-of-sight link is blocked by an object. The modern 5G and future 6G communications, as well as WiFi or alike communication standards, use frequencies that have wide bandwidth potential available for the high-speed communications. For example, 5G FR2 bands arise from 24.25 GHz and currently go up to 52 GHZ, while 6G is envisioned to operate, for instance above 100 GHz and 300 GHz frequencies. Also, IEEE802.11 systems operate at 5-6 GHz and 60 GHz frequencies. These systems are in particular well suitable for imaging due to the fact that the bandwidth potential is wide, while the penetration loss and reflection properties of the materials and objects are often highly frequency selective. In addition, in these frequencies, the systems use highly directive beams which means that the RF properties of the object also depends highly on the object position with respect to the link or the transmitted and received beams. Furthermore, the radio implementation in these frequencies is envisioned to be highly integrated which enables high commercial market potential and mass production with decent price.

In an embodiment, the transmitter 14 may comprise a radio access network node, NodeB of a wireless communication network, a base station of a wireless communication network, a second mobile station and/or a relay transmitter as an example. A relay may be also implemented as an intelligent reflective surface or other a passive or active repeater arrangement, for example.

The transmitter and/or receiver may use various different communication systems and standards such as 1G, 2G, 3G, 4G, 5G, 6G standards, Wi-Fi, Wireless local area network (WLAN), 802.11a, 802.11b, 802.11 g, 802.11n, 802.11ac, 802.11ax standards, a Bluetooth®, an ultra-wideband (UWB), a wireless universal serial bus (USB), a Zigbee, EDGE, EV-DO x1 Rev 0, Rev A, Rev B and x3 standards, Fast Low-latency Access with Seamless Handoff (FLASH)—Orthogonal Frequency Division Multiplexing (OFDM), GPRS, HSPA D and/or U standards, Lorawan, LTE, RTT, UMTS over W-CDMA, UMTS-TDD, WiMAX: 802.16 standard, Narrowband IoT, Wireless personal area network (WPAN) and most wireless sensor actor networks (WSAN), 6LoWPAN, Bluetooth V4.0 with standard protocol and with low energy protocol, IEEE 802.15.4-2006 (low-level protocol definitions corresponding to the OSI model physical and link layers), 6LoWPAN, ANT, ANT+, MiraOS a wireless mesh network from LumenRadio or the like.

The radio link between the transmitter 14 and the receiver 16 is affected by the object 12, which has an impact on the received signal information of the receiver 16. For example, the object 12 may be carried by a carrier, for example a human, such the object 12 or even different parts of the object is moving between the transmitter 14 and the receiver 16 and/or with respect to the transmitter 14 and/or the receiver 16. The object 12 may be within the Fresnel zone at least temporally (see FIG. 8). In that case, the radio link itself does not have accurate control on a position and/or orientation of the object 12 and the object 12 may be moving randomly or almost randomly from the radio link perspective that may result in rather random impacts on the received signal. However, the at least on optical image capturing unit 18 gathers information on the position and/or orientation of the object 12.

The data processing unit 10 forms a radio frequency image of the object 12 from both of the at least one radio frequency property and the information on position and/or orientation of the object 12. For forming the radio frequency image, the data processing unit 10 utilizes temporal relation between the at least one radio frequency property from at least one operational radio frequency and information on the position and/or orientation of the object 12. The temporal relation between the at least one radio frequency property from at least one operational radio frequency and information on the position and/or orientation of the object 12 may refer to temporal closeness. The temporal relation and/or closeness between the at least one radio frequency property and information on the position and/or orientation of the object 12 may refer to synchronization. That is, the at least one radio frequency property and the information on position and/or orientation of the object 12 may be measured at a same moment of time, or the moments may be connected in post processing phase.

The same moment does not need be exactly the same moment. Instead, the same moment means the same moment within a tolerance or a required/desired resolution. Different sampling rates of digital systems may result in a time difference within a tolerance, and hence the same moment of time refers to samples that are taken synchronously at moments that are adjacent or directly adjacent to each other. If a sampling rate is 1 kHz, movement of the object 12 made by a human being or a mammal 20 does not necessarily have a significant difference in the at least one property between two directly successive samplings. Hence, the required resolution may allow that the at least one radio frequency property and the information on position and/or orientation of the object 12 that are utilized have a timing difference of 0.01 s or 0.1 s. In some cases where the object 12 moves slowly, the timing difference between the at least one radio frequency property and the information on position and/or orientation of the object 12 may be 1 s or even larger. In this manner, the temporal relation or the synchronization may be utilized adaptively.

Also, time instants of the position and/or orientation information on the captured optical image, and/or time instants of the information on the captured radio frequency image may be interpolated based on the multiple measurements to match each other more accurately. For example with a certain speed of the object 12, a position of the object 12 may be interpolated between the multiple optical images captured at different time instants or extrapolated outside the range within the samples have been collected.

The measured radio frequency property of the object 12 can thus be linked with the position and/or orientation of the object 12. As the object 12 is non-stationary, i.e. it is moving, more than two-dimensional information or information on more than two degrees of freedom may also be acquired from the object 12. For example yaw, pitch and roll may be included in the information.

The radio frequency imaging apparatus comprises or is connected with a radio frequency receiver 16, which receives radio frequency radiation interacted with a non-stationary object 12. The radio frequency receiver 16 forms, as a function of time, at least one property of the radio frequency radiation interacted with the non-stationary object 12.

The radio frequency imaging apparatus also comprises or is connected with at least one optical image capturing unit 18, which captures optical images of the non-stationary object 12.

The at least one optical image capturing unit 18 is an example of at least one data gathering unit 18. Each or at least part of them gathers information on position and/or orientation of the object 12 with respect to the direction the radio frequency radiation and the position of the receiver means 16, as a function of time. They also form, as a function of time, information on position and/or orientation of the object 12 within the radio frequency radiation from the gathered data. The data gathering unit 18 may comprise an acceleration sensor, which may be one dimensional, two dimensional or three dimensional, or a magnetic sensor, which may operate in a range from one dimensional to 6-axes sensing, for example.

Similarly, the data gathering unit 18 may use various other techniques to measure information on the position and/or orientation of the object 12 such as Lidar, optical sensors or other position sensors. These techniques for determining the information on the position and/orientation of the object 12 may be implemented also on radio frequencies. For example, radar techniques can be used to track the position and/or orientation of the object 12 in various ways.

The text will continue with the example of the at least one image capturing unit 18′, it should be understood that the image capturing unit 18′ may be replaced with the data gathering unit 18 anywhere where it is not expressly a question of optical images.

The information on the position and/or orientation of the object 12 may also be directly in the coordinates of the object pixel in an optical image. Hence, in that case, the information on the position and/or orientation is not necessarily a position information in cartesian coordinate system measured in a dimensional unit, but a pixel coordinates measured in a number of pixels in different spatial domains. For example, this may refer to a case where the object coordinates, and/or transmitter coordinates, and/or receiver coordinates with respect to the propagation environment are defined as pixel coordinates in an optical image; in that case, the pixel object coordinates, noted as for example X and Y (in pixels), gives the X and Y coordinates for the image, while the measured radio signal information gives the function values f(X,Y). In such a case, the optical camera image and the corresponding radio image may, as a function of time, contain similar coordinate system. In that manner, the information on position and/or orientation of the object 12 may be defined based on either a coordinate system of the optical image or a coordinate system of physical space of the object 12.

The at least one image capturing unit 18′ forms, as a function of time, information on position and/or orientation of the object 12 within the radio frequency radiation based on the optical images. The at least one optical image capturing unit 18′ is directed toward the object 12 and may be adaptively directed. In an embodiment, the direction may be controlled by the data processing unit 10. The at least one optical image capturing unit 18′ may comprise a CCD (Charge Coupled Device) camera and/or a CMOS (Complementary Metal Oxide Semiconductor) camera. In an embodiment, the at least one optical image capturing unit 18′ may comprise one or more line cameras. The line camera may have a one dimensional array as a detector cell. In an embodiment, the at least one optical image capturing unit 18′ may have a two-dimensional pixel matrix as detector cell. The movement of the object 12 enables formation of the position and/or orientation information with both kinds of cameras.

The at least one image capturing unit 18′ may also capture an image of the receiver 16 and/or the transmitter 14. This may be used to better determine the position of the object 12 with respect to the transmitter 14 and/or receiver 16. In a special scenario, the at least one image capturing unit 18 may be placed in such a way that the object 12 itself is outside the field of view of the at least one image capturing unit 18. In such a scenario, if we assume that the object 12 is at least almost static with respect to the physical environment, it is enough to form a radio image of the object 12 only based on the position and/or orientation of the transmitter 14 and/or receiver 16.

In an embodiment, the object 12 may comprise at least one of the at least one image capturing unit 18′. In such a case, the at least one of the at least one image capturing unit 18′ may be at least partly in or on the object 12.

In an embodiment, the optical image capturing unit 18′ may operate on infrared light, where the optical image is formed based on information on camera detector elements which are suitable for detecting infrared radiation. Instead of the about 400 nm to about 700 nm range of a visible light camera, which may additionally or alternatively be used as the optical image capturing unit 18′, infrared cameras are sensitive to wavelengths from about 1,000 nm (1 micrometer or μm) to about 14,000 nm (14 μm), for example.

FIG. 2 illustrates an example of the data processing unit 10. The data processing unit 10 can carry out at least one process 20 on an electric signal received from the interaction with the object 12, and the at least one process outputs the at least one radio signal property based on the interaction from at least one radio frequency. The data processing unit 10 can carry out at least one process 22 on the electric signal received from the interaction with the object 12 and time stamps it or registers otherwise the timing of the interaction. The data processing unit 10 can carry out at least one process 24 on the at least one optical image of the object 12 and the at least one process 24 outputs information on the position and/or orientation of the object 12. Then the data processing unit 10 can form the radio frequency image of the object 12 based on these pieces of information in a process 26. As these processes are ongoing and are performed repeatedly, a cumulative information on the object 12 can be gathered from the object 12.

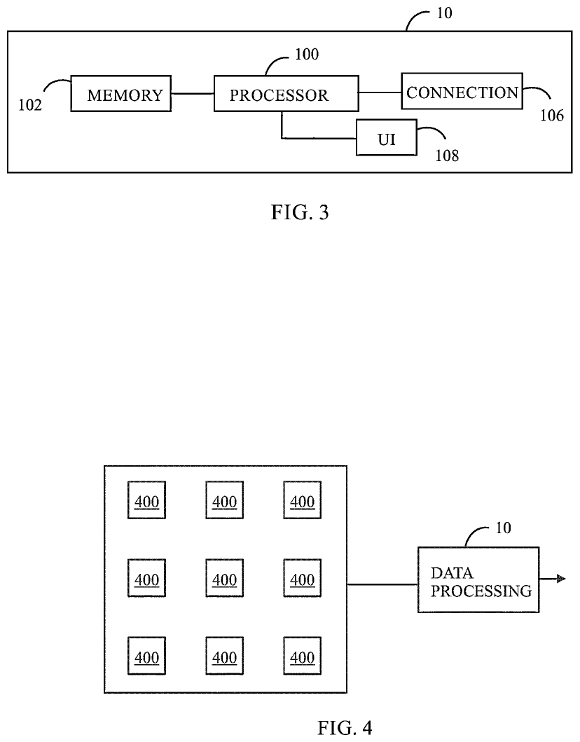

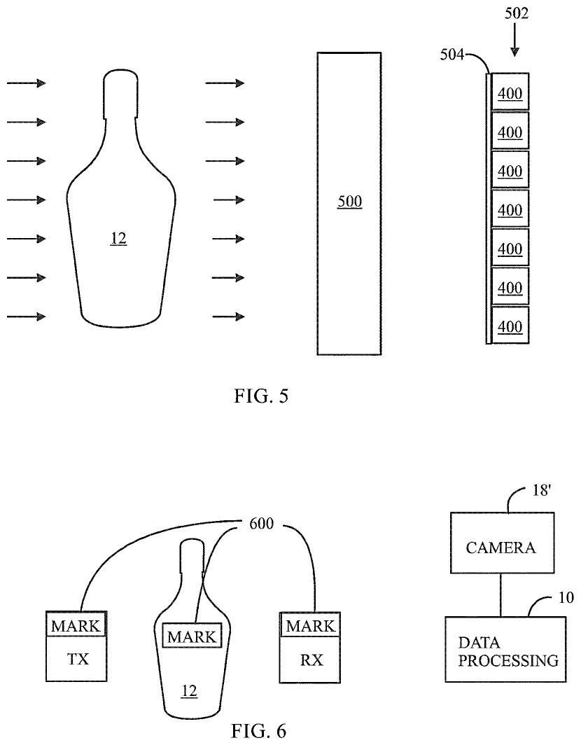

FIG. 3 illustrates an example of the data processing unit 10, which, in an embodiment, may comprise one or more processors 100, and one or more memories 102 including computer program code. The one or more memories 102 and the computer program code may be configured to, with the one or more processors 100, control at least the optical image capturing means 18′ to capture the optical images of the non-stationary object 12 as a function of time, and form, as a function of time, the information on position and/or orientation of the object 12 from the optical images.

The one or more memories 102 and the computer program code may be configured to, with the one or more processors 100, control the radio frequency receiver 16 to receive, as a function of time, the radio frequency radiation interacted with the non-stationary object 12, and form, as a function of time, the at least one property of the radio frequency radiation interacted with the non-stationary object 12 within the radio frequency radiation.

The one or more memories 102 and the computer program code may be configured to, with the one or more processors 100, form the at least one radio frequency image of the object 12 from both of said information on position and/or orientation of the object 12 and the at least one property of the radio frequency radiation interacted with the non-stationary object 12 based on temporal relation between the at least one radio frequency property and the position and/or orientation of the object 12 in the formation of the radio frequency image.

The at least one data processing unit 10 may also comprise a connection element 106, which may be electromechanical connector. The electromechanical connector may be a USB-connector (Universal Serial Bus), for example. The connection element 106 may a wireless connector which connects the at least one data processing unit 100 with an external device using electromagnetic signaling, acoustic signaling and/or optic signaling, for example.

The at least one data processing unit 10 may also comprise a user interface 108, which may comprise a keyboard, a mouse and/or a touch screen, for example. The user interface 108 may be used to input and output data and present the radio frequency image(s).

The user interface may be implemented in a various kind of devices such as TV, personal computer (PC), laptop, tablets, mobile phones, wearables, virtual classes or the like.

In an embodiment, the data processing unit 10 may compare the at least one property of the radio frequency radiation interacted with the object 12 with the at least one property of the radio frequency radiation without the interaction with the object 12 for forming the radio frequency image. Here, the property that that is measured without the object 12 can be considered a reference, and any variation with respect to the reference can be considered an image of the object 12.

A numerical reference as such is not mandatory as the measured radio signal property is a function of a position and/or orientation of the object 12. As the object 12 moves with respect to the radio link over time, the measured radio signal property has different values when measured for different positions and/or orientations of the object 12. In some positions of the object 12, the radio signal property is affected less by the object 12 than with some other position and/or orientation of the object 12. Hence, this radio signal property dynamics gives the range of the values for the radio frequency image. For example, if the measured radio signal property is the received signal strength (RSS), the maximum RSS value gives a red color pixel, while the lowest RSS value gets a blue color pixel, for example. Then the dynamics of the received signal values are mapped into a corresponding image colors, for example (colormap vs signal dynamics).

It is clear that a radio image may take various forms of a function and may be illustrated in various kind of visualization methods such as plots, graphs, curves, planes, shapes, videos, contour-plots or the like, which, per se, a person skilled in the art is familiar with.

Note that the radio frequency image is likely interpolated between the pixels to virtually improve the resolution and make smooth transitions between pixel colors. Same applies to different kinds of radio frequency images or three-dimensional models that can be created based on the radio frequency image information.

In an embodiment, the data processing unit 10 may form the radio frequency image based on at least one of the following signal quality properties of the radio frequency radiation: power, received signal strength (RSS), received signal strength indicator (RSSI), amplitude, phase, frequency response, channel state information, beam index/indices, beam direction(s), signal polarization(s), request for retransmission, bit error rate (BER), symbol error rate (SER), frame error rate (FER), block error rate (BLER), signal quality, signal-to-noise ratio (SNR), and error vector magnitude (EVM) or the like that is available in the system. Additionally or alternatively, the data processing unit may construct the radio frequency image based on radio frequency quality indicators, which are derived based on the actual communication signal data for example the data rate changes of the radio link, changes in the used modulation, pilot symbols or the signal header information, a channel quality indicator (CQI), or based on any actual payload data changes which are related to the quality of the radio link. The signal information may be also any combination of at least two different types of signal information.

The measured values of the at least one property of the radio frequency signal vary during the interaction with the non-stationary object 12 and as each image forming unit receives radio frequency signal from different portions of the object 12 at different moments, a “black-and-white” image that represents a distribution of the values over the object 12 can be formed. If a plurality of properties are measured, a “color” image of the object 12 may be formed.

Different values of the signal or at least one property of the radio frequency signal may be mapped to different colors in the radio image by using different colormaps. The dynamics in the colormap may be scaled in such a way that different changes in the radio signal properties would represent different colors in the image. In this way, it is clear that the colors in the radio image may represent different values of the signal property and colors may be changed in such a way that the radio image is clearly visible.

If only one property is measured, for example RSS, in multiple positions of the object 12, an image can be formed that may be black/white or may have a variety of colors. It is merely a way how to define a colormap for the figure, i.e. what values (ranges of values) represent what color in the image. There are many different kinds of colormaps, so even with two different values of a single signal property one can form an image that has colors. In this light, a color picture can be formed by using a certain colormap, i.e. dynamics of how different values of a certain signal property maps to a certain color of a pixel in the image. And of course an image with color or a black and white image can also be formed when more than one property is measured.

In an embodiment, the at least one optical image capturing unit 18′ may perform object detection and/or object tracking in order to form the information on position and/or orientation of the object 12 from the optical images. The object detection and/or object tracking may be based on artificial intelligence driven computer vision which is known by a person skilled in the art, per se. The object detection and/or object tracking may be performed in the data processing unit 10 and the data processing unit 10 may also control the direction of the at least one optical image capturing unit 18′ in order to keep the object 12 or a distinct detectable mark of the object 12 within a field-of-view of the at least one optical image capturing unit 18′.

The transmitter TX 14 and/or receiver RX 16 and/or the environment may be equipped by the at least one optical image capturing unit 18′ that may track the object 12 using machine vision (MV) techniques, for example. Even with a single optical image capturing unit 18′ placed close to the RX/TX 14, 16, the optical image capturing unit 18′ may accurately track the position and orientation of the object 12 with respect to the direct link chord. The position information may contain one (1D), two (2D), three-directional (3D) position of the object 12, and in addition the information may contain (multidimensional) orientation of the object 12 and/or the TX and/or RX, i.e. and/or 6-axes position/orientation of the object 12.

The information on position and/or orientation of the object 12 may include the pixel coordinates of the object, or the portion of the object, in the optical image in addition to or instead of physical information on position and/or orientation of the object 12 with respect to its real environment. In this way, the position and/or orientation coordinates of the object 12 in a given coordinate system may not necessary directly relate to the physical object position in space, but the position in the optical image.

The position information of the object 12 and received radio signal information are synchronized in time such that the received signal information can be mapped to a certain position and/or orientation of the object 12 with respect to the link. The synchronization of the radio frequency information i.e. radio frequency property of the object 12 and the optical image information are in the radio frequency image synthesis. When the object 12 is moving with respect to the radio link over time, the system can measure the “pixels” of the radio image in different time instants without a requirement for controllable positioners to accurately move the object 12 in between the radio link.

Using object detection and/or object tracking or both, it is possible to estimate accurately geometric two-dimensional (2D) or even three-dimensional (3D) position and/or orientation of the object 12 in an optical image and a video. There are many existing video tracking techniques using Kalman filtering, mean adaptive shift (CAM shift), Kanade-Lucas-Tomasi (KLT), optical-flow etc. that are easily available to implement on different hardware platforms like mobile phones. Currently, deep Simple Real Time Tracker (SORT) is the most widely used object tracking algorithm which works on the principles of integrating the object appearance information from image processing with artificial intelligence methods. With the recent advancements in computer vision, it is even possible to perform tracking with real-time object detection over every frame of the video sequence using methods like You Only Look Once (YOLO), Single Shot Detector (SSD), Attention networks etc. This is due to the fact that even a simple photo or image itself already contains lots of redundant pixel information of the object 12. Hence, deriving meaningful features of the object from such information combined with motion information of camera or object, can accurately determine the detection and tracking of the object 12.

As there is movement between the object 12 and the radio frequency signal and/or between the object 12 and the receiver 16 over time (for example by a human being), the data processing unit 10 can track the orientation and/or the position of the object 12 and generate the radio frequency image without using high number of physical pixels. Note that if the radio link is highly directive, even very small mobility, for example a natural vibration of a human hand, can enable high number of virtual pixels of the radio frequency image.

In an embodiment an example of which is illustrated in FIG. 4, the receiver 16 may comprise one or more receiving elements 400. Each of the receiving elements 400 may form at least one property of the radio frequency radiation interacted with a portion of the non-stationary object 12 at a moment. Each of the receiving element 400 may comprise an antenna and a preprocessing unit, which may comprise a radio frequency mixer and a band-pass filter or some parts of a complete radio signal path. In alternative embodiment, the receiving element 400 may have an antenna and a complete radio receiver, or a radio transmitter, or a radio transceiver. Each of the receiving elements 400 may form at least one property of the radio frequency radiation interacted with another portion of the non-stationary object 12 at another moment. The data processing unit 10 may then form the radio frequency image of the portions of the object 12 based on the at least one property formed at said moments.

In an embodiment, the data processing relating to the at least one property of the radio frequency radiation may be performed in the at least one data processing unit 10 in a series form based on the receptions of the optical image and the radio frequency signals.

FIG. 1 illustrates a radio link from the transmitter 14 (TX) to the receiver 16 (RX). The TX and RX may contain multiple antennas, and they may have multiple simultaneous directive beam(s) and multiple links. Also, the TX and RX may have directive radiation patterns, or the beam(s) can be focused by using focusing antennas such as radio lenses, or near-field focusing. The radio links may utilize various propagation phenomena. For example, one or more of the links may utilize line-of-sight (LOS) propagation, reflections (specular and/or diffuse reflections), penetration, scattering, diffraction or alike. One or more of the links may be also created by using relays, reconfigurable intelligent surfaces, intelligent reflective surfaces, meta-surfaces, or other alike passive or active repeater arrangements. In this way, it is clear for a person skilled in art that the radio links can use various different propagation phenomena to transmit and receive radio signals that potentially interact with the object 12. Similarly, it is clear that the interaction with the object 12 may be any of these propagation phenomena.

In an embodiment, the receiver 16 may comprise radio frequency focusing component 500, which may form a focused radio frequency image 504 on a deterministically arranged array 502 of receiving elements 400. An electric form of the radio frequency image comprises information on the at least one property of the radio frequency radiation focused on deterministically arranged array 502 of receiving elements 400. The radio frequency focusing component 500 may be based on suitable spatial phase shifting of the radio frequency radiation.

In an embodiment, the data processing unit 10 may form a three-dimensional radio frequency image of the object 12 in response to the interaction between the radio frequency radiation and the object 12 that has turned round an axis that is perpendicular to a propagation direction of the radio frequency radiation. The axis may go through the object 12.

In an embodiment, the radio frequency image formation by the data processing unit 10 may be based on an estimation that the radio frequency radiation is at least approximately collimated prior to the interaction with the object 12.

In an embodiment, the radio frequency receiver 16 may receive the radio frequency radiation that has passed through the object 12. The data processing unit 10 may form one or more shadow images of the object 12. A shadow image is formed when a non-transparent or partially transparent object 12 is between the transmitter 18′ and the receiver 16 and blocks at least partly the propagation of the radio frequency radiation.

In an embodiment, the radio frequency receiver 16 may receive at least two different wavelengths of the radio frequency radiation. The data processing unit 10 may then form at least one radio frequency image based on the at least two different wavelengths, the at least one radio frequency image representing one or more structural and/or compositional features of the object 12.

In an embodiment, at least one of the object 12, the radio frequency receiver 16 and a radio frequency transmitter 14 comprises an optically detectable reference mark 600 a representation of which the data processing unit 10 may detect in the optical image. The data processing unit 10 may then determine the location and/or orientation of the object 12 with respect to the reference mark 600. The mark may be a name, a symbol, trademark, or other sign that identifies the object 12 that is it or that carries it.

The mark 600 is a distinctive pattern that is a detectable part of the object 12 and that can be used to track its position and/or orientation with the at least one optical image capturing unit 18′. The mark 600 can be the whole object 12, but it can be much smaller than the object 12 as well a figure, shape, sub-shape, pattern, a dot, logo, etc. that is clearly visible in the object 12.

In an embodiment, the optical image capturing unit 18′, the radio frequency receiver 16 and the data processing 10 may be included in a portable and/or wearable user device. The user device may be implemented as an electronic digital computer, processing system or a circuitry which may comprise a working memory (random access memory, RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The computer program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

In an embodiment, the radio frequency imaging apparatus 10 may comprise a radio frequency transmitter 14, which is configured to transmit radio frequency radiation toward the object 12.

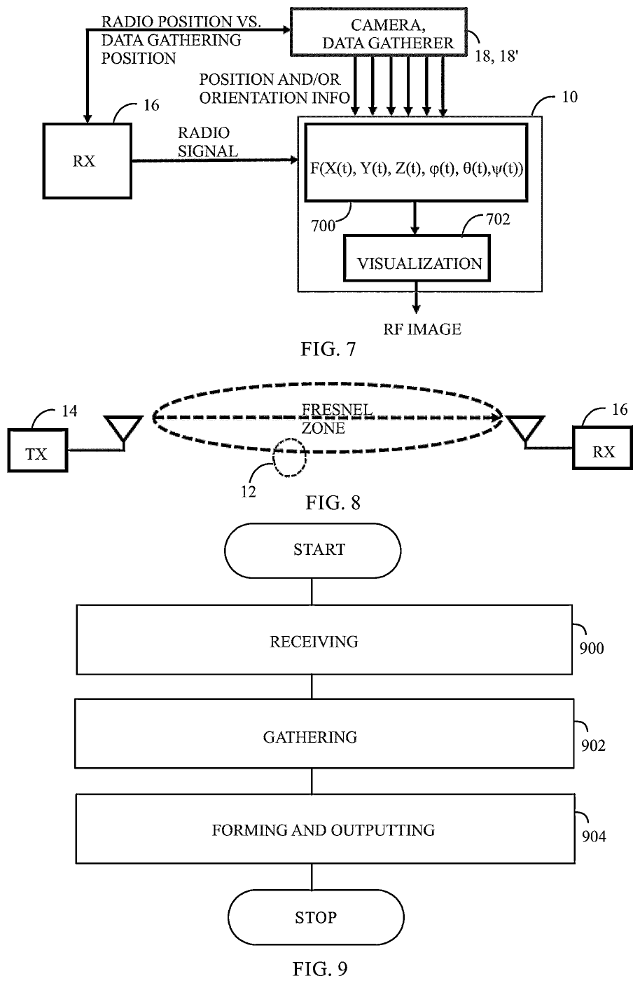

FIG. 7 illustrates an example of radio frequency image formation. Position and/or orientation information on the object 12 can be defined in many different coordinate systems. For generalization, one can use a 6-axis coordinate system commonly used in robotics, where, in addition to standard X, Y, Z-coordinate axes, one defines a rotation of each of the coordinate axis as phi (φ), theta (θ), psi (ψ), where φ may refer to roll, θ may refer to pitch and w may refer to yaw, for example.

The instant when the at least one optical image capturing unit 18′ takes a picture and the instant when radio frequency receiver 16 collects the signal property has to be synchronized with an accuracy inversely proportional to the mobility of object 12 with respect to the radio link ends. The synchronization can be arranged in various ways, for example, using triggers, or it can be synchronized afterwards in the post processing phase by varying the time and/or sample offset between the camera pictures and RF properties. In the synchronization process, the system may also use interpolation or extrapolation such that the object positions and the radio signal information capture instants can be more accurately synchronized.

A computation part 700 of the data processing unit derives the position and/or orientation information on the object 12 in the form of X, Y, Z, φ, θ, ψ-coordinate axes, for example. Here X, Y and Z refer to three-dimensional location of the object, and φ may refer to pitch of the object 12, θ may refer to roll of the object 12 and ψ may refer to yaw of the object 12, for example. Hence, the position and/or orientation of the object 12 is a function of these variables in or for the radio frequency image. Then a visualization apparatus 702 of the data processing unit 10 generates an RF image/video/3DModel of the object 12 based on the radio signal and optical image data.

In an embodiment, the radio link with a transmitter 14 and a receiver 16 used for imaging may be a radar transmitting and receiving electromagnetic radio frequency signals.

In an embodiment, the position tracking of the object 12 may use a secondary wireless system. For example, the secondary wireless system may operate in different radio frequency than the system from which the radio signal information is formed to determine the property of the pixel in the radio image. For example, the secondary wireless system may operate in higher center frequency than the first system that is used to collect the radio signal information to form a radio image. In this way, the system can form the radio image in another frequency by using information on the position and/or orientation of the object 12 determined in secondary frequency that may have better capabilities to determine the position and/or orientation of the object 12.

In an embodiment, the position tracking technique may be applied for measuring the radiation pattern of an antenna, TX, and/or RX, or other equipment containing radiating or receiving the radio waves. Such system may be useful in a radio transmitter, a radio receiver or a radio transceiver testing without requirements for accurate positioners in a complicated laboratory environment. For example, the at least one optical image capturing unit 18′ and/or the data gathering unit 18 may track the position of the probe testing antenna, TX 14 and/or RX 16. The at least one optical image capturing unit 18′ may be attached to a device in which the TX, RX and/or a probe antenna is operating such that the at least one optical image capturing unit 18′ can track the position (including orientation) of the radio link with respect to the object 12. The radio image and combined visual, and/or other gathered information, and radio image can be used to visualize the radio beam direction, width and accuracy of the tested radio equipment and such radio parameter testing is called over-the-air (OTA) testing. These tests are carried out during research and development phase of the radio equipment, during manufacturing of the equipment and during regulatory tests of the final radio equipment. That is, the data processing unit 10 may visualize a beam of the radio frequency radiation based on the optical and radio frequency image. The visualization may be performed using the user interface 108.

In an embodiment, the object can for example an RFID, passive repeater, RIS, or the like. This kind of object 12 may be useful in testing, for example.

In an embodiment, the system can operate in a mobile device, such as smart phone, virtual reality classes, laptop, a wearable device, and/or a tablet that is equipped with a camera as an optical image capturing unit 18′ and a radio TX 14 and/or RX 16. For example, the system can be implemented as an app on a mobile device that are very often equipped with high quality cameras. Hence, in such a case, the app installed in the mobile device can be used to scan objects in radio frequencies by using existing radio access points such as Wi-Fi router(s), radio base station(s) or other mobile device. Due to the fact that the camera is installed in the same device as the radio TX and/or RX, the camera can easily track the object 12 from the radio link's perspective. The camera may also track the other link end (for example a base station) such that it can better determine the position and/or orientation of the object 12 with respect to the radio link.

In an embodiment of the invention, the system may contain multiple cameras that can better define the position and/or orientation of the object 12.

In an embodiment, the position and/or orientation tracking may be used along with the other existing imaging systems to virtually increase the number of radio imaging pixels. For example, if the radio imaging systems (passive or active) can measure 256 pixels with the same device, the image tracking can increase the number of pixels by the same 256 in every time instant. Hence, using the camera-based tracking can significantly increase the number of pixels of the existing imaging systems.

In an embodiment, the system can use multiple radio links that may operate in different frequencies, different polarizations, or and/or different physical locations to determine the frequency specific electrical and geometric properties of the object 12. Similarly, the system may use frequency specific signal information, such as signal information of different carriers in a multi-carrier system to determine the frequency specific electrical and geometric properties of the object 12.

In an embodiment, the invention may be used to read written text from a paper. For example, the invention can be used to read text inside an envelope or a package using the fact that ink used for writing has different electrical properties (for example different penetration loss), than the surrounding paper. In this, the regular camera is tracking a certain feature visible in the envelope/parcel, while the radio link monitors the content inside the envelope/parcel.

FIG. 8 illustrates an example of a relationship between a size of the object 12 and the wavelength used in the radio frequency imaging. Hence, smaller objects 12 are easier to detect with higher operating frequencies where the wavelength is smaller. Reason for this is two-folded.

1. In high frequencies, narrower beams are generally used to fight against the increased path loss.

2. Even small objects may easily have high influence on the signal when propagating from a transmitter 14 to a receiver 16. This can be explained by using a Fresnel zone that is commonly used in communication systems to define if the object has influence on the link. Often the link is defined as line-of-sight, if a certain amount of first Fresnel zone is free from objects. The Fresnel zone is defined as a function of wavelength. Hence, a smaller wavelength (higher frequency) means more distinct impact of an object 12 with respect to the link.

High operating frequencies are likely to be used in 6G systems, for example. Also, it should be noted that the radio link distance is also likely to be smaller in high operating frequencies which allows easy and reliable use.

It should be noted that the radio image can give different information about the object 12 than the regular camera. The radio image may contain information of the shape of the object, electromagnetic properties of the object, material(s) of the object. For example, the radio image can determine the material(s) of the object based on its electrical properties. Similarly, the radio link can see inside the object 12. This applies for example to the case depicted in FIG. 1, where the radio image contains information about the liquid content of the bottle. Similarly, the radio image can determine content of a carboard box or other alike package that is not transparent for visible light. This enables numerous applications that are may not be possible with only camera-based solutions.

TABLE 1
Detectable object size versus wavelength of the operation frequency.

| | Frequency | | | | | | | | | | | | |
|---|---|---|---|---|---|---|---|---|---|---|---|---|---|
| | 700 | | 1.0 | | 2.0 | | 3.5 | | 24 | | 39 | | 300 |
| | MHz | | GHz | | GHz | | GHz | | GHz | | GHz | | GHz |
| Wavelength | 42.9 | cm | 30.0 | cm | 15.0 | cm | 8.6 | cm | 1.3 | cm | 0.8 | cm | 0.1 cm |
| 15 | 6.4 | m | 4.5 | m | 2.3 | m | 1.3 | m | 18.8 | cm | 10.4 | cm | 1.5 cm |
| wavelengths | | | | | | | | | | | | | |

| | | | | | | | |
|---|---|---|---|---|---|---|---|
| Example | large | mid- | small | human | head | hand | finger |
| object | van | size | city car | body | | palm | |
| | | car | | | | | |

FIG. 9 is a flow chart of the measurement method. In step 900, radio frequency radiation interacted with a non-stationary object 12 is received by a radio frequency receiver, the non-stationarity of the object 12 relating to at least one of the following: a direction from which the radio frequency radiation is configured to hit the object 12, a position of the receiver means 16.

In step 902, information on position and/or orientation of the object 12 is gathered by a data gathering unit 18, as a function of time, and form as a function of time, information on position and/or orientation of the object 12 within the radio frequency radiation from the gathered data.

In step 904, at least one radio frequency image of the object 12 is forming and output from both of said information on position and/or orientation of the object 12 and the at least one property of the radio frequency radiation interacted with the non-stationary object 12 by a data processing unit 12, based on utilization of temporal relation between the at least one radio frequency property and information on the position and/or orientation of the object 12 in formation of the radio frequency image.

The method shown in FIG. 9 may be implemented as a logic circuit solution or computer program. The computer program may be placed on a computer program distribution means for the distribution thereof. The computer program distribution means is readable by a data processing device, and it encodes the computer program commands, carries out the measurements and optionally controls the processes on the basis of the measurements.

The computer program may be distributed using a distribution medium which may be any medium readable by the controller. The medium may be a program storage medium, a memory, a software distribution package, or a compressed software package. In some cases, the distribution may be performed using at least one of the following: a near field communication signal, a short distance signal, and a telecommunications signal.

What is presented in this document may be used in numerous applications. Such applications may be, for example, security screening, material study, transceiver over-the-air measurements, maintenance, entertainment, etc. If the applications are implemented in regular communication devices such as mobile phone, the imaging systems may be available for numerous consumers and may serve as a platform for wide range of different kind of services and applications. The presented features may be used to enable the radio frequency imaging in an existing communication system, or it can be used to enhance the performance of an existing radio frequency imaging system.

It will be obvious to a person skilled in the art that, as technology advances, the inventive concept can be implemented in various ways. The invention and its embodiments are not limited to the example embodiments described above but may vary within the scope of the claims.

1. A radio frequency imaging apparatus, wherein the radio frequency imaging apparatus comprises:
a radio frequency receiver means, which is configured receive radio frequency electromagnetic radiation interacted with a non-stationary object and form, as a function of time based on tomography, at least one property of the radio frequency radiation interacted with and passed through the object that blocks partly the propagation of the radio frequency radiation through the object, the non-stationarity of the object relating to at least one of the following: a direction of the radio frequency radiation with respect to the object, a position of the receiver means;
data gathering means, which is configured to gather information on position and/or orientation of the object as a function of time, and form as a function of time, information on position and/or orientation of the object within the radio frequency radiation from the gathered data; and
a data processing means, which is configured to form at least one radio frequency image of the object from both of said information on position and/or orientation of the object and the at least one property of the object based on the radio frequency radiation interacted with the object and inside of the object, the data processing means being configured to utilize temporal relation between the at least one radio frequency property and information on the position and/or orientation of the object in formation of the radio frequency image.

2. An apparatus of claim 1, wherein the apparatus comprises one or more processors, and one or more memories including computer program code;
the one or more memories and the computer program code configured to, with the one or more processors, control at least
an optical image capturing means of the data gathering means to capture the optical images of the object as a function of time, and form, as a function of time, the information on position and/or orientation of the non-stationary object from the optical images;
the radio frequency receiver means to receive, as a function of time, the radio frequency radiation interacted with the non-stationary object, and form, as a function of time, the at least one property of the radio frequency radiation interacted with the non-stationary object within the radio frequency radiation; and
the data processing means to form at least one radio frequency image of the object from both of said information on position and/or orientation of the object and the at least one property of the radio frequency radiation interacted with the non-stationary object based on temporal relation between the at least one radio frequency property and the position and/or orientation of the object in the formation of the radio frequency image.

3. The apparatus of claim 1, wherein the data processing means is configured to compare the at least one property of the radio frequency radiation interacted with the non-stationary object with the at least one property of the radio frequency radiation without the interaction with the non-stationary object for forming the radio frequency image.

4. The apparatus of claim 1, wherein the data processing means is configured to form the radio frequency image based on at least one of the following properties of the radio frequency radiation: power, received signal strength, received signal strength indicator, amplitude, phase, frequency response, channel state information, beam index/indices, beam direction(s), signal polarization(s), request for retransmission, bit error rate, symbol error rate, frame error rate, block error rate, signal quality, signal-to-noise ratio, error vector magnitude, data rate changes of the radio link, changes in modulation, pilot symbol, signal header information, channel quality indicator, payload data changes which are related to the quality of the radio link.

5. The apparatus of claim 1, wherein an optical image capturing means of the data gathering means are configured to perform object detection and/or object tracking in order to form the information on position and/or orientation of the object from the optical images.

6. The apparatus of claim 1, wherein the receiver means comprise one or more receiving elements, and each of the receiving elements is configured to form at least one property of the radio frequency radiation interacted with a portion of the non-stationary object at a moment;
at least a part of the receiving elements is configured to form at least one property of the radio frequency radiation interacted with another portion of the non-stationary object at another moment; and
the data processing means is configured to form the radio frequency image of the portions of the object based on the at least one property formed at said moments.

7. The apparatus of claim 1, wherein the data processing means is configured to visualize a beam of the radio frequency radiation based on the optical and radio frequency image.

8. The apparatus of claim 1, wherein the data processing means is configured to form a three dimensional radio frequency image of the object in response to the interaction between the radio frequency radiation and the object that has turned round an axis that goes through the object and that is perpendicular to a propagation direction of the radio frequency radiation.

9. The apparatus of claim 1, wherein the information on position and/or orientation of the object is defined based on either a coordinate system of the optical image or a coordinate system of physical space of the object.

10. The apparatus of claim 1, wherein the radio frequency receiver means is configured to receive the radio frequency radiation that has passed through the object; and the data processing means is configured to form one or more shadow images of the object.

11. The apparatus of claim 1, wherein the radio frequency receiver means is configured to receive at least two different wavelengths of the radio frequency radiation; and the data processing means is configured to form at least one radio frequency image based on the at least two different wavelengths, the at least one radio frequency image representing one or more structural and/or compositional features of the object.

12. The apparatus of claim 1, wherein at least one of the object, the radio frequency receiver means and a radio frequency transmitter means comprises an optically detectable reference mark a representation of which the data processing means are configured to detect in the gathered information, and determine the location and/or orientation of the non-stationary object with respect to the reference mark.

13. The apparatus of claim 1, wherein an optical image capturing means of the data gathering means, the radio frequency receiver means and the data processing means are included in a portable and/or wearable user device.

14. The apparatus of claim 1, wherein the apparatus comprises a radio frequency transmitter means, which is configured to transmit radio frequency radiation toward the non-stationary object.

15. The apparatus of claim 14, wherein a radio frequency transmitter means comprises at least one of the following: a radio access network node, NodeB of a wireless communication network, a base station of a wireless communication network, a Wi-Fi transmitter, a Bluetooth® transmitter, an ultra-wideband transmitter, a wireless universal serial bus transmitter, a mobile device, a relay transmitter and a Zigbee transmitter.

16. A radio frequency imaging method, the method comprising receiving, by a radio frequency receiver means, radio frequency radiation interacted with and passed through a non-stationary object that blocks partly the propagation of the radio frequency radiation through the object, the non-stationarity of the object relating to at least one of the following: a direction of the radio frequency radiation with respect to the object, a position of the receiver means;
gathering, by a data gathering means, information on position and/or orientation of the object as a function of time based on tomography, and form as a function of time, information on position and/or orientation of the object within the radio frequency radiation from the gathered data;
forming, by the radio frequency receiver means as a function of time, at least one property of the radio frequency radiation interacted with the non-stationary object; and
forming and outputting, by a data processing means, at least one radio frequency image of the object from both of said information on position and/or orientation of the object and the at least one property of the object based on the radio frequency radiation interacted with the non-stationary object and inside of the object by utilizing temporal relation between the at least one radio frequency property and information on the position and/or orientation of the non-stationary object in formation of the radio frequency image.
